(19) United States
(12) Patent Application Publication
(10) Pub. No.: US 2016/0189274 A1
(43) Pub. Date: Jun. 30, 2016

(54) FASHION ADMINISTRATION

(71) Applicant: eBay Inc., San Jose, CA (US)

(72) Inventors: Matthew MacLaurin, San Jose, CA (US); Timothy Carlson, San Jose, CA (US); Corinne Sherman, San Jose, CA (US); Bria Selhorst, San Jose, CA (US); David Ramadge, San Jose, CA (US)

(21) Appl. No.: 14/587,645

(22) Filed: Dec. 31, 2014

(51) Int. Cl. G06Q 30/06; G06Q 50/00; G06Q 30/02; G06F 17/30

(52) U.S. Cl. CPC G06Q 30/0631; G06F 17/30595; G06Q 50/01; G06Q 30/0282

(57) ABSTRACT

A system may include a feature detector, an information gatherer, a trend identifier, a fashion database, a preference identifier, and a recommendation engine. The feature detector may analyze images including visual data showing apparel. The feature detector may determine characteristics of the apparel. The information gatherer may identify non-visual data related to the images and may derive non-visual details related to the apparel. The trend identifier may identify defined trends embodied by the apparel based on the characteristics of the apparel. The fashion database may store and categorize fashion metrics of the apparel, including the characteristics, the defined trends, and the non-visual details related to the apparel. The preference identifier may identify fashion preferences of a customer. The recommendation engine may present a fashion recommendation to the customer based at least in part on a comparison of the fashion preferences of the customer and the fashion metrics.

### BACKGROUND

1. Field

The embodiments discussed herein are related to fashion administration.

2. Technology

Shopping for apparel can be an inefficient exercise in terms of time and effort. Fashion preferences may vary widely and finding apparel consistent with particular personal fashion preferences may demand significant effort. For example, a relatively significant amount of time may be spent browsing apparel for sale online, traveling to physical stores, looking through apparel not consistent with personal fashion preferences, trying on apparel, and the like, just to purchase relatively few items of apparel. Furthermore, apparel well-suited for particular fashion preferences may be available, although the person with the particular fashion preferences may not know of its existence.

Advertising and selling apparel may be similarly inefficient. Significant resources may be expended in an attempt to present a customer with apparel options that may be compatible with their personal fashion preferences. In the case of online marketplaces, customers may be given high-level filters based on simple characteristics such as brand, color, size, item type, and the like. More particular recommendations may be given, typically based on the browsing and/or purchasing habits of other users of the marketplace. However, such recommendations may not present a customer with recommendations consistent with the customer's particular fashion preferences.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

To further clarify the above and other advantages and features, a more particular description will be rendered by reference to specific embodiments thereof, which are illustrated in the appended drawings. These drawings depict only example embodiments and are therefore not limiting of scope. Embodiments will be described and explained with additional specificity and detail through the use of the accompanying drawings in which:

FIG. 1 is a diagram of an example fashion classification and recommendation system;

FIG. 2 is a diagram of an example fashion classification system; and

FIG. 3 is a diagram of an example fashion recommendation system.

### DESCRIPTION

Online marketplaces may face challenges in presenting apparel to potential customers. Often, online marketplaces may offer more and/or different styles of apparel for purchase than a physical apparel store. Online marketplaces may include apparel from a multitude of brands and periods, as well as unique apparel. By comparison, a physical apparel store may include relatively fewer brands, which may be limited to current styles. The online marketplace may provide a customer with a number of ways to filter and/or sort the apparel so the customer may attempt to locate apparel the customer wants to purchase from among the potentially vast amount of available apparel. For example, the marketplace may allow customers to filter and/or sort apparel broadly by type, by color, by cost, by brand, by rating, by popularity, and the like. However, such filtering and/or sorting may be inefficient in presenting a customer with apparel the customer may consider purchasing. In some cases, inefficiencies may arise when the apparel presented to a particular customer is not consistent with the particular customer's fashion preferences.

In some embodiments, a fashion administration system may address the inefficiencies experienced by online marketplaces in presenting apparel to customers. In some embodiments, the fashion administration system may include a fashion classification system, and/or a fashion recommendation system.

In some embodiments, the fashion administration system may build and maintain a collection of fashion metrics associated with the apparel. The fashion metrics may include characteristics of the apparel; trends embodied by the apparel; information regarding the apparel, the characteristics, the trends, and the like; or the like or any combination thereof. As used herein, apparel may include garments and/or accessories worn and/or carried by a person, including head coverings, shirts, ties, pants, skirts, dresses, hats, scarves, outerwear, purses, jewelry, or the like or any combination thereof. As used herein, apparel may alternately or additionally include cosmetics, such as makeup and/or nail polish; body modification, such as tattoos and/or piercings; hair styles, such as haircut styles, hair coloring, and/or facial hair styles; or the like, or any combination thereof.

In some embodiments, the fashion administration system may identify and collect data regarding trends embodied by the apparel or by combinations of apparel. Alternately or additionally, the fashion administration system may identify new trends based on the relative prevalence of particular characteristics of the apparel, and may maintain information regarding the trends, including a history, popularity, geographical prevalence, seasonal prevalence, and/or the like for each trend.

Alternately or additionally, the fashion administration system may identify and/or collect information regarding fashion preferences of a customer and may present the customer with recommendations consistent with the customer's preferences. The recommendations may include recommendations of particular apparel, apparel characteristics, trends, or the like, or some combination thereof.

In some embodiments, the fashion administration system may direct a customer to apparel the customer may be more likely to purchase because the apparel is consistent with the customers' preferences. The fashion administration system may mitigate some of the problems associated with presenting apparel in an online marketplace. Alternately or additionally, the fashion administration system may inform the customer of trends consistent with the customer's personal preferences, which may provide the customer with motivation and/or confidence to purchase apparel that the customer may not have purchased otherwise. Thus, apparel commerce may be made more efficient for the marketplace and/or the customer. The fashion administration system may particularly improve the presentation of apparel to customers via an online marketplace, where vast amounts of apparel may be for sale, potentially more than a customer could practically consider within a single shopping session.

In some embodiments, a system may include a feature detector, an information gatherer, a trend identifier, a fashion database, a preference identifier, and a recommendation engine. The feature detector may analyze images including visual data showing apparel. The feature detector may determine characteristics of the apparel. The information gatherer may identify non-visual data related to the images and may derive non-visual details related to the apparel. The trend identifier may identify defined trends embodied by the apparel based on the characteristics of the apparel. The fashion database may store and categorize fashion metrics of the apparel, including the characteristics, the defined trends, and the non-visual details related to the apparel. The preference identifier may identify fashion preferences of a customer. The recommendation engine may present a fashion recommendation to the customer based at least in part on a comparison of the fashion preferences of the customer and the fashion metrics.

In some embodiments, a fashion classification system may include a feature detector, an information gatherer, a trend identifier, and a fashion database. The feature detector may analyze images including visual data showing apparel and may determine characteristics of the apparel from the visual data. The information gatherer may identify non-visual data related to the images and may derive non-visual details related to the apparel included in the images. The trend identifier may identify potential trends based at least in part on a frequency at which particular characteristics of the apparel are identified by the feature detector. The trend identifier may further deliver to a human consultant information regarding characteristics associated with the potential trends. The trend identifier may further receive from the human consultant verification of potential trends as defined trends. The trend identifier may further identify the defined trends embodied by the apparel based on the characteristics of the apparel identified by the feature detector. The fashion database may store and categorize fashion metrics, including the characteristics of the apparel, the defined trends embodied by the apparel, and the non-visual details related to the apparel.

In some embodiments, a fashion recommendation system may include a feature detector, an information gatherer, a preference identifier, a preference database, and a recommendation engine. The feature detector may analyze images associated with a customer, the images including visual data showing apparel. The feature detector may determine characteristics of the apparel from the visual data. The information gatherer may identify non-visual data related to the images and may derive non-visual details related to the apparel. The preference identifier may identify fashion preferences of the customer based at least in part on the characteristics of the visual apparel. The preference database may store the fashion preferences of the customer. The recommendation engine may present a fashion recommendation to the customer based at least in part on a comparison of the fashion preferences of the customer and fashion metrics of apparel available for purchase from a marketplace.

Reference will now be made to the figures wherein like structures will be provided with like reference designations. The drawings are diagrammatic and schematic representations of example embodiments and, accordingly, are not limiting of the scope of the claimed subject matter, nor are the drawings necessarily drawn to scale.

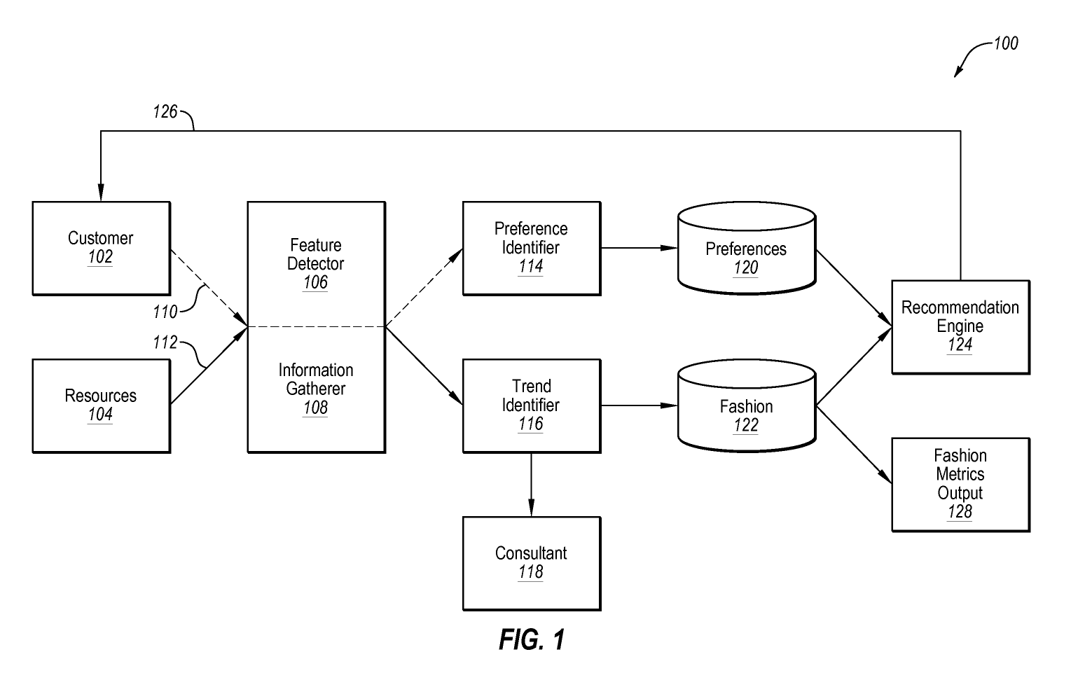

FIG. 1 is a diagram of an example fashion classification and recommendation system 100 (herein “system 100”). In some embodiments, the system 100 may be employed by an online marketplace to provide a customer 102 with apparel recommendations 126. The recommendations 126 may include apparel available for purchase through the online marketplace. An online marketplace may include a network-based website and/or application for allowing a customer to purchase products such as apparel.

Advantageously, the recommendations 126 may be consistent with the fashion preferences of the customer 102, which may result in a more efficient shopping experience for the customer 102 and/or the marketplace. In some instances, the customer 102 may spend less time browsing before and/or between apparel purchases and may be exposed to new products consistent with the fashion preferences of the customer 102 that the customer 102 may not have encountered during conventional browsing. Thus, the system 100 may address some of the problems faced by online marketplaces.

The system 100 may include a feature detector 106 and/or an information gatherer 108. The feature detector 106 and/or the information gatherer 108 may analyze resources 104 for fashion information 112. The fashion information 112 and/or the resources 104 may be global in the sense that the resources 104 and/or the fashion information 112 may not be specific to the customer 102. The resources 104, for example, may include images of the customer 102 and/or apparel associated with the customer 102.

The resources 104 may include images including visual data showing apparel. For example, the resources 104 may include videos and/or images of people wearing various articles of apparel, images of apparel, or the like, or any combination thereof. The resources 104 may include images of apparel for sale and/or previously offered for sale via an online marketplace such as a marketplace employing the system 100. Alternately or additionally, the resources 104 may include images and/or videos available via search engines, and/or social media sites, including image-sharing and/or video-sharing sites, interest-sharing sites, and the like. In some instances, video data and/or frames from video data may be treated in the same manner as image data. Alternately or additionally, the images may include images captured particularly for the system 100. For example, images from past and current issues of a magazine may be captured, videos such as popular movies and/or television shows may be added, and the like.

In some embodiments, the resources 104 may include images from fashion-related sources. For example, images from fashion magazines, fashion blogs, fashion designer websites, fashion shows, apparel advertisements, apparel retailers, and the like may be included as resources 104.

The feature detector 106 may employ machine-based feature detection. For example, machine-based image feature detection may be used to analyze a store of various images to determine which images include apparel. Machine-based image feature detection may also be used to determine characteristics of the apparel. For example, the feature detector 106 may use image feature detection to identify characteristics of the apparel, such as apparel type, colors, patterns, cut, presence of fashion elements, relative location of fashion elements, or the like, or some combination thereof. In some embodiments, the feature detector 106 may employ facial recognition to attempt to identify the person wearing the apparel, particularly where the person wearing the apparel is a celebrity or other public figure.

In some embodiments, the feature detector 106 may identify visual characteristics of the people wearing the apparel. For example, the feature detector 106 may identify physical characteristics such as height, expressed gender, facial characteristics, hair length, hair color, complexion, size and/or shape of various body parts, apparent age, or the like, or any combination thereof.

The feature detector 106 may employ machine learning to improve the feature detection. For example, an image may include a hat with what the feature detector 106 identifies as a polka-dot pattern. The feature detector 106 may process another image that shows the same hat from another angle, which may reveal that the polka-dot feature identified is actually an array of spikes. The feature detector 106 may revise the original identification and may identify indicators for differentiating spikes from polka-dots going forward.

The information gatherer 108 may include a machine-based information gatherer 108. The information gatherer 108 may find and/or collect non-visual details regarding the apparel and/or images being analyzed by the feature detector 106. The non-visual details may include any fashion or historically-based information related to the image, the apparel shown in the images, the person wearing the apparel, the location where the image was captured, circumstances surrounding the image captured, or the like, or some combination thereof.

For example, the information gatherer 108 may identify text associated with an image. The text may be found on a website with the image, may be included on the image, or the like. The text may identify information regarding the apparel, the person wearing the apparel, the location and/or the date and time the image was captured, the author's opinion regarding the apparel, information regarding trends embodied by the apparel, the designer of the apparel, or the like, or some combination thereof. Alternately or additionally, the information gatherer 108 may identify metadata regarding the image, including a location, a date and time the image was captured, keywords associated with the image, an author and/or copyright holder associated with the image, or the like, or some combination thereof.

The system 100 may include a trend identifier 116 for identifying trends in the features detected and/or the information gathered by the feature detector 106 and/or the information gatherer 108, respectively. The trend identifier 116 may include a machine-based trend identifier 116. In some embodiments, the trend identifier 116 may recognize that a previously nonexistent or uncommon characteristic or combination of characteristics has been identified by the feature detector 106 and/or the information gatherer 108. Alternately or additionally, the trend identifier 116 may recognize that the information gatherer 108 has associated particular images and/or apparel with a particular phrase or the like. Alternately or additionally, the trend identifier 116 may consider a relative volume of characteristics, particular items of apparel, and/or particular combinations of characteristics and/or apparel. For example, the trend identifier 116 may recognize a significant increase in the rate at which the feature detector 106 identifies images of hats having gold spikes on them, or of people wearing a particular scarf and pant combination, or of a particular color being popular.

Alternately or additionally, the trend identifier 116 may consider a source, gathered by the information gatherer 108, of the images in identifying the potential trends. The trend identifier 116 may attribute more influence to particular sources. For example, characteristics, combination of characteristics, or particular items of apparel may be considered more likely to embody some trend or trends if the related images originated with or are otherwise associated with particular sources. For example, images associated with traditionally trend-setting blogs, designers, celebrities, and/or retailers may be given greater weight in identifying trends than images associated with relatively less fashion-conscience sources.

In some embodiments, the trend identifier 116 may consider a weighted volume in identifying potential trends. For example, the trend identifier 116 may assign each source a weight and the weighted volume of a potential trend may include a sum of the weights of the sources of the images including the potential trend. Thus, characteristics appearing in a relatively few images associated with relatively highly-weighted sources may be as likely to be identified as a potential trend as characteristics appearing in relatively many images associated with relatively lowly-weighted sources.

In some embodiments, the trend identifier 116 may automatically define trends based on the potential trends identified by the trend identifier 116. For example, the trend identifier 116 may determine that the information gatherer 108 has gathered information describing the characteristics and/or a name associated with a defined trend. In some embodiments, the trend identifier 116 may generate a trend name for the defined trend. The trend name generated by the trend identifier 116 may be based on the characteristics associated with the defined trend, names of trends similar to the defined trend, or the like, or some combination thereof.

In some embodiments, the trend identifier 116 may send information regarding potential trends to a human consultant 118 (herein “consultant 118”). The consultant 118 may include someone knowledgeable about apparel, fashion, fashion trends, and the like. The trend identifier 116 may send the consultant 118 any relevant information regarding the potential trend, including the characteristics the trend identifier 116 has identified as embodying the potential trend, exemplary images of apparel embodying the potential trend, the date and/or location associated with the first appearance of the potential trend, a timeline showing a prevalence of the potential trend over time, publications that have included images of apparel embodying the potential trend, celebrities who have worn apparel embodying the potential trend, fashion designers possibly associated with the potential trend, information regarding defined trends similar to the potential trend and the differences between the defined trends and the potential trends, or the like or any combination thereof.

The consultant 118 may verify the potential trend as a defined trend to the trend identifier 116. Alternately or additionally, the consultant 118 may identify the potential trend as an extension and/or an evolution of a similar trend. For example, the consultant 118 may identify the differences between the potential trend and a similar defined trend as being practically imperceptible or too minor to warrant a new defined trend. Alternately, the consultant 118 may instruct the trend identifier 116 to treat the potential trend as defined trend, but may instruct the trend identifier 116 to classify the newly defined trend as derivative to one of the similar defined trends (e.g., as a defined variation of the similar trend). Alternately or additionally, the consultant 118 may provide the trend identifier 116 with a name for the potential trend and/or the defined trend.

Alternately, the consultant 118 may instruct the trend identifier 116 that the potential trend is not actually a trend. For example, the trend identifier 116 may incorrectly identify costumes, generic apparel pairings, colors associated with professional sports teams, or the like, as potential trends. In some embodiments, the trend identifier 116 may employ machine learning with the feedback from the consultant 118 to attempt to reduce or eliminate the number of incorrectly identified potential trends.

The features detected by the feature detector 106, the information gathered by the information gatherer 108, and/or the trends identified by the trend identifier 116 may be described generally as fashion metrics. The fashion metrics may be stored and/or categorized in a fashion database 122. Optionally, images may be included in the fashion database 122. In some embodiments, the fashion metrics for each item of apparel may be organized in a vector in which each element of the vector corresponds to a fashion metric and/or a characteristic of the apparel.

In some embodiments, the recommendation system 100 may include fashion metrics output 128. The fashion metrics output 128 may provide information regarding particular items of apparel, including the characteristics of the apparel, the trends embodied by the apparel, other items of apparel including the same or similar characteristics as the particular items of apparel, celebrities that have worn the apparel, when and/or where the apparel design originated, designers associated with the apparel, or the like, or some combination thereof. Alternately or additionally, the fashion metrics output 128 may provide information regarding trends, including characteristics of the trends, items of apparel that embody and/or are associated with the trends, designers associated with the trends, celebrities that have worn the trends, relative popularity of the trends, the relative popularity of trends in various areas and/or at various times. The fashion metrics output 128 may direct the customer 102 to new apparel, new trends, or the like. Alternately or additionally, the fashion metrics output 128 may provide a resource that may bring the customer 102 to the marketplace and/or may provide the customer 102 with access to apparel available via the marketplace.

The feature detector 106 and the information gatherer 108 may analyze resources associated with the customer 102 for customer information 110. The customer information 110 may include information that associates the customer 102 with particular apparel, fashion trends, body characteristics, interests, demographics, celebrities, designers, or the like, or any combination thereof. In some embodiments, the customer information 110 may include information regarding the characteristics of models the customer 102 may be drawn to when considering the apparel worn by the models. For example, the customer 102 may be more likely to like apparel worn by tall, redheaded models that appear to be in their early twenties. The customer information 110 may be gathered from multiple sources and may include deliberate inputs from the customer 102 and/or analysis of information associated with the customer 102, but not deliberately provided by the customer 102. In some embodiments, images of the customer 102 may be identified within the resource 104 via facial recognition, so-called tags in social media, image captions, and the like.

In some embodiments, the customer information 110 may include inputs from an internet-based application for providing the customer information 110 to the system 100. For example, the customer 102 may identify apparel that the customer 102 likes and/or dislikes via a website or an application installed on a computer or a mobile device such as a smartphone or a tablet computer. In some embodiments, the customer 102 may upload images of apparel, identify images of apparel online, and/or capture images of the customer 102 wearing apparel the customer 102 likes and/or dislikes and the feature detector 106 and/or the information gatherer 108 may analyze the images. In some embodiments, uploaded or identified images may have been previously analyzed by the feature detector 106 and/or the information gatherer 108, in which case the feature detector 106 and/or the information gatherer 108 may forego additional analysis of the images. Alternately or additionally, the system 100 may present images to the customer 102 and the customer 102 may indicate whether the customer 102 likes or dislikes the apparel shown in the images.

Alternately or additionally, the customer information 110 may include a history of the customer 102. For example, the customer information 110 may include information regarding apparel the customer 102 has bid on, placed on a watch list, placed on a wish list, viewed repeatedly, purchased via an online marketplace, or some combination thereof. Alternately or additionally, the customer information 110 may include social media associated with the customer 102. For example, the customer information 110 may include apparel-related information associated with a social network associated with the customer 102, such as a message-sharing network, an image- and/or video-sharing network, an interest-sharing network, or the like.

In some embodiments, the customer information 110 may include an identification of websites that the customer 102 has browsed and/or that the websites recorded as viewed by the customer 102. Alternately or additionally, the customer information 110 may include web address referrers and/or search engine query terms associated with the customer 102 navigating to an online marketplace. Alternately or additionally, the customer information 110 may include web addresses of websites navigated to by the customer 102 after leaving the online marketplace.

The system 100 may include a preference identifier 114 for identifying preferences of the customer 102. In some embodiments, the preference identifier 114 may include a machine-based preference identifier 114. In some embodiments, the preference identifier 114 may identify common characteristics of apparel liked by the customer 102. Alternately or additionally, the preference identifier 114 may identify common characteristics of the apparel disliked by the customer 102.

In some embodiments, the preference identifier 114 may identify whether some of the customer information 110 may not be attributed to the customer 102. For example, the customer 102 may purchase, consider, and/or otherwise show interest in apparel that the customer 102 is considering for another person, such as a significant other, a relative, a friend, or the like. In some embodiments, the preference identifier 114 may ignore features and/or information related to apparel having outlying characteristics in identifying the preferences of the customer 102.

In some embodiments, the preference identifier 114 may identify trends embodied by the characteristics of the apparel liked and/or disliked by the customer 102. Thus, the preference identifier 114 may identify trends consistent with and/or inconsistent with the personal style of the customer 102. The preference identifier 114 may consider the characteristics of the apparel liked and/or disliked by the customer 102 in light of the defined trends identified, validated, and/or named by the trend identifier 116 and/or the consultant 118.

The preferences of the customer 102 may be stored in a preferences database 120 and updated as additional customer information 110 is analyzed by the feature detector 106 and/or the information gatherer 108, and is considered by the preference identifier 114. The preferences database 120 may include information regarding a timing of the preferences of the customer 102 to account for changing preferences of the customer 102.

The system 100 may include a recommendation engine 124. In some embodiments, the recommendation engine 124 may include a machine-based recommendation engine 124. The recommendation engine 124 may compare the preferences of the customer 102 from the preferences database 120 to the apparel and/or trends in the fashion database 122. The recommendation engine 124 may consider the timing of the customer 102 preferences. For example, if the customer 102 liked apparel embodying a particular trend several months prior, but has not appeared to like the trend recently, and/or has disparaged the trend via social media, the recommendation engine 124 may consider the customer 102 as being over the trend and may avoid making recommendations 126 based on the particular trend.

Alternately or additionally, the recommendation engine 124 may consider the timing of preferences of the customer 102 relative to the timing of public trends and may alter the recommendations 126 accordingly. For example, the recommendation engine 124 may determine that the customer 102 prefers to adopt some trends as the trends are relatively unknown and/or not adopted by the larger public, and that the customer 102 prefers to avoid and/or stop wearing apparel embodying trends that have become relatively commonplace among the public.

Alternately or additionally, the recommendation engine 124 may consider the preferences of the customer 102 relative to the preferences of the public. For example, in generating recommendations 126 for the customer 102, the recommendation engine 124 may consider whether the tastes of the customer 102 may be fashion forward, retro, geographically influenced (e.g., the customer 102 may prefer trends popular in urban areas, a particular university, a particular city, a particular region of a country, a particular country, and the like). Alternately or additionally, the recommendation engine 124 may consider whether the preferences of the customer 102 tend to follow trends worn, designed, and/or promoted by particular public figures such as celebrities, fashion designers, and the like. In some embodiments, the recommendation engine 124 may consider seasonal influences of the preferences of the customer 102. For example, the customer 102 may prefer local trends for winter apparel and may like non-local trends for summer apparel.

Thus, for example, the recommendation engine 124 may generate recommendations 126 embodying trends that the customer 102 has not directly indicated that the customer 102 likes. For example, the recommendation engine 124 may recommend new and/or upcoming trends that the customer 102 may not have seen yet, but are consistent with the preferences of the customer 102 or have a significant likelihood of being adopted by the customer 102 based on past trends adopted by the customer 102.

In some embodiments, the recommendation engine 124 may generate recommendations 126 base on the characteristics of the customer 102 relative to the characteristics of other people classified within the fashion database 122. For example, the preference identifier 114 may determine that the customer 102 plays particular sports, is a particular age, lives in a particular area, and/or has particular body characteristics. Furthermore, the recommendation engine 124 may make recommendations 126 of apparel associated with people in the fashion database 122 having related characteristics. For example, if particular apparel is commonly associated with retired athletes, the recommendation engine 124 may recommend the apparel if the particular characteristics identified for the customer 102 suggest that the customer 102 may be inclined to purchase the apparel for the same reasons the retired athletes use the apparel and/or because the customer 102 may be influenced by the athletes' (perhaps unintentional) endorsement of the apparel.

In some embodiments, the recommendations 126 may include custom apparel consistent with the personal style of the customer 102. For example, the recommendations 126 may include an article of apparel that may not be available for purchase, but includes a combination of characteristics consistent with the preferences of the customer 102 identified by the preference identifier 114. In some embodiments, if such recommendations 126 are selected by the customer 102, the characteristics of the custom apparel may be delivered to an apparel manufacturer, who may create the custom apparel for the customer 102.

In some embodiments, the system 100 may be used to make recommendations 126 regarding the customer 102 to someone other than the customer 102. For example, the recommendation system 100 may be used to generate recommendations 126 so that someone may purchase apparel for the customer 102 that is consistent with the preferences of the customer 102. Thus, for example, the recommendations 126 may be for the customer 102, but may be delivered to someone other than the customer 102.

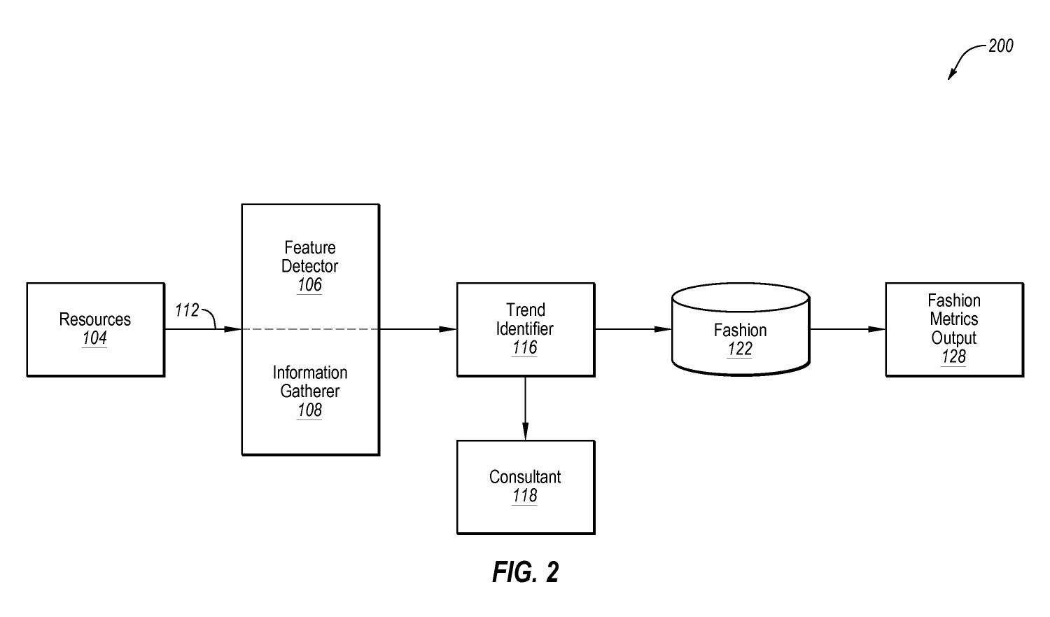

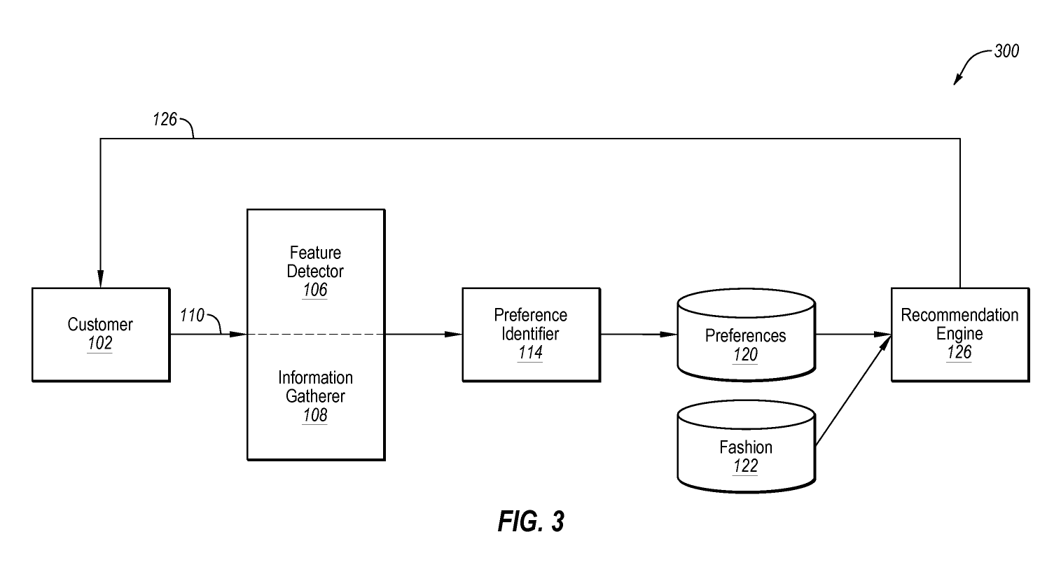

FIG. 2 is a diagram of an example fashion classification system 200. FIG. 3 is a diagram of an example fashion recommendation system. In some embodiments, a portion of the system 100 of FIG. 1 may be used and/or the system 100 may be split into separate systems, potentially resulting in the fashion classification system 200 of FIG. 2 and/or the fashion recommendation system 300 of FIG. 3. In some embodiments, the fashion classification system 200 and the fashion recommendation system 300 may be used by different entities. For example, the fashion classification system 200 may be run by a fashion classification entity that populates the fashion database 122 for use by multiple entities employing the fashion recommendation system 300. Alternately or additionally, the fashion classification system 200 may provide a fashion metric output for the public or the like.

The embodiments described herein may include the use of a special-purpose or general-purpose computer including various computer hardware or software modules, as discussed in greater detail below. In some embodiments, the feature detector 106, the information gatherer 108, the preference identifier 114, the trend identifier 116, the recommendation engine 124, and/or the fashion metrics output 128 may be performed by a processor of a special-purpose or general-purpose computer. Alternately or additionally, the preferences database 120 and/or the fashion database 122 may be located in a storage or a memory of a special-purpose or general-purpose computer.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include tangible computer-readable storage media including random-access memory (RAM), read-only memory (ROM), electrically erasable programmable read-only memory (EEPROM), compact disc read-only memory (CD-ROM) or other optical disk storage, magnetic disk storage or other magnetic storage devices, or any other storage medium that may be used to carry or store desired program code in the form of computer-executable instructions or data structures and that may be accessed by a general-purpose or special-purpose computer. Combinations of the above may also be included within the scope of computer-readable media.

Computer-executable instructions include, for example, instructions and data that cause a general-purpose computer, special-purpose computer, or special-purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system comprising:
a machine-based feature detector for analyzing images including visual data showing apparel, the feature detector configured to determine characteristics of the apparel from the visual data;
a machine-based information gatherer for identifying non-visual data related to the images and deriving non-visual details related to the apparel included in the images;
a machine-based trend identifier for identifying defined trends embodied by the apparel based on the characteristics of the apparel identified by the feature detector;
a fashion database for storing and categorizing fashion metrics, including the characteristics of the apparel, the defined trends embodied by the apparel, and the non-visual details related to the apparel;
a machine-based preference identifier for identifying fashion preferences of a customer based at least in part on a portion of the apparel associated with the customer; and
a machine-based recommendation engine for presenting a fashion recommendation to the customer based at least in part on a comparison of the fashion preferences of the customer and the fashion metrics.

2. The system of claim 1, wherein the trend identifier identifies potential trends based at least in part on a frequency at which particular characteristics of the apparel are identified by the feature detector.

3. The system of claim 1, wherein the trend identifier identifies potential trends based at least in part on non-visual details related to the images from which particular characteristics of the apparel are identified by the feature detector.

4. The system of claim 1, wherein the trend identifier identifies potential trends based at least in part on relative weights associated with sources of the images.

5. The system of claim 1, wherein the trend identifier identifies potential trends and delivers to a human consultant information regarding characteristics associated with the potential trends, example images of apparel embodying the potential trends, and non-visual details related to the potential trends.

6. The system of claim 5, wherein the trend identifier classifies a particular potential trend as a defined trend in response to receiving verification of the particular potential trend and a name of the particular potential trend from the consultant.

7. The system of claim 1, further comprising a preference database for storing the fashion preferences of the customer.

8. The system of claim 1, wherein the fashion recommendation includes at least one article of apparel available for purchase from a marketplace.

9. The system of claim 1, wherein the portion of the apparel associated with the customer includes at least one of:
an article of apparel given a positive rating by the customer,
an article of apparel given a negative rating by the customer,
apparel worn by the customer, and
apparel owned by the customer.

10. The system of claim 9, wherein:
apparel given a positive rating by the customer includes apparel in images related to social media associated with the customer; and
apparel worn by the customer includes apparel worn by the customer in the images that include the customer.

11. An online marketplace including the system of claim 1.

12. A fashion classification system comprising:
a machine-based feature detector for analyzing images including visual data showing apparel, the feature detector configured to determine characteristics of the apparel from the visual data;
a machine-based information gatherer for identifying non-visual data related to the images and deriving non-visual details related to the apparel included in the images;
a machine-based trend identifier for:
identifying potential trends based at least in part on a frequency at which particular characteristics of the apparel are identified by the feature detector,
delivering to a human consultant information regarding characteristics associated with the potential trends,
receiving from the human consultant verification of potential trends as defined trends, and
identifying the defined trends embodied by the apparel based on the characteristics of the apparel identified by the feature detector; and
a machine-based fashion database for storing and categorizing fashion metrics, including the characteristics of the apparel, the defined trends embodied by the apparel, and the non-visual details related to the apparel.

13. The fashion classification system of claim 12, wherein the trend identifier identifies potential trends based at least in part on non-visual details related to the images from which the particular characteristics of the apparel are identified by the feature detector.

14. The fashion classification system of claim 12, wherein the trend identifier further delivers to the human consultant example images of apparel embodying the potential trends and non-visual details related to the potential trends.

15. A fashion recommendation system comprising:
a machine-based feature detector for analyzing images associated with a customer, the images including visual data showing apparel, the feature detector configured to determine characteristics of the apparel from the visual data;
a machine-based information gatherer for identifying non-visual data related to the images and deriving non-visual details related to the apparel included in the images;
a machine-based preference identifier for identifying fashion preferences of the customer based at least in part on the characteristics of the visual apparel;
a preference database for storing the fashion preferences of the customer; and
a machine-based recommendation engine for presenting a fashion recommendation to the customer based at least in part on a comparison of the fashion preferences of the customer and fashion metrics of apparel available for purchase from a marketplace.

16. The fashion recommendation system of claim 15, wherein the fashion recommendation includes at least one article of apparel available for purchase from an online marketplace associated with the system.

17. The fashion recommendation system of claim 15, wherein the images associated with the customer include at least one of:
an image including an article of apparel given a positive rating by the customer,
an image including an article of apparel given a negative rating by the customer,
an image including apparel worn by the customer, and
an image including apparel owned by the customer.

18. The fashion recommendation system of claim 17, wherein the image including an article of apparel given a positive rating by the customer includes a social media image associated with the customer.

19. The fashion recommendation system of claim 17, wherein the image including apparel worn by the customer further includes the customer.

20. An online marketplace including the fashion recommendation system of claim 17, wherein the apparel owned by the customer includes apparel purchased by the customer from the online marketplace.
